(19) United States
(12) Patent Application Publication
(10) Pub. No.: US 2004/0214583 A1
(43) Pub. Date: Oct. 28, 2004

(54) Method and apparatus for forecasting growth of wireless telecommunications systems

(76) Inventors: Joseph Milton Graham, Coral Springs, FL (US); Sylvester Freeman, Marietta, GA (US)

Correspondence Address: GARDNER GROFF, P.C., PAPER MILL VILLAGE BUILDING 23, 600 VILLAGE TRACE, SUITE 300, MARIETTA, GA, 30067, US

(21) Appl. No.: 10/811,342

(22) Filed: Mar. 26, 2004

Related U.S. Application Data
(60) Provisional application No. 60/459,240, filed on Mar. 28, 2003.

(51) Int. Cl. H04Q 7/20

(52) U.S. Cl. 455/453; 455/446; 455/423

(57) ABSTRACT

Embodiments of the invention include a method, an apparatus, a computer readable medium and a system for forecasting growth within a wireless telecommunications system. The method includes determining current system traffic for the wireless system, determining current minutes of use (MOU) for the current wireless system, estimating future MOU for the wireless system, and forecasting future system traffic for the wireless system based on the system's current traffic, current MOU, and future estimated MOU. The method also is useful for estimating spectrum requirements and balance between coexisting technologies, determining the impact of relief sectors proposed for the wireless system at future points in time, and determining the consequence of different system growth alternatives. Also, the growth forecasting method allocates the forecasted future system traffic throughout the existing system in a suitable manner, e.g., according to the percentage contribution of each system sector to the existing system traffic. The growth forecasting method incorporates growth factors and buffer amounts as part of the system traffic forecasting. For example, the future MOU estimating step can include MOU and subscriber count buffer amounts. Also, the future MOU estimating step can incorporate growth factors including an MOU growth factor and an individual sector busy hour (ISBH) growth factor to reflect system growth rates during peak usage and non-peak usage. The growth forecasting method is suitable for wireless systems that use one or more different existing technologies, e.g., Global System for Mobile Communications (GSM), Advanced Mobile Phone Service (AMPS), Time Division Multiple Access (TDMA), and Code Division Multiple Access (CDMA). Also, the growth forecasting method is compatible with existing system traffic offload algorithms.

### CROSS-REFERENCE TO RELATED APPLICATIONS

This application claims the benefit of U.S. Provisional Application Ser. No. 60/459,240 filed Mar. 28, 2003.

### BACKGROUND OF THE INVENTION

1. Field of Invention

The invention relates to wireless telecommunications systems. More particularly, the invention relates to methods and devices for forecasting the growth of voice channel traffic in wireless telecommunications systems.

2. Description of the Related Art

The explosive growth of wireless telecommunications services has spawned the corresponding growth of wireless system hardware, software, and system management needs for the providers of wireless telecommunications services. As the number of wireless customers increases, the demands placed on existing wireless telecommunications system infrastructure grows. Accordingly, system service providers often are faced with decisions regarding the expansion of system infrastructure to meet current and future demands.

Wireless telecommunications systems typically include a cluster or network of sectors or cells, with each sector providing a coverage area. Each sector typically includes a central radio transmitter/receiver base station (BS) for communicating with a plurality of mobile stations (MS) that are within the sector at a given time. Mobile stations include handheld personal units (e.g., cell phones) and other mobile communications devices that are used while in motion within the sector coverage area. A system mobile services switching center (MSC) coordinates the routing of communications within the sector coverage area, e.g., communications between the mobile stations and the base stations. The MSC also provides communications between the base stations and a fixed telecommunications network, such as the fixed Public Switched Telephone Network (PSTN).

As the number of wireless subscribers increases and the amount of traffic within a wireless system grows, system service providers face the problem of if, when, and how to expand system infrastructure to meet the growing needs. For example, system providers must decide whether to add base stations within existing sectors, or whether to add additional sectors and/or radios within the system. The timing of the added base stations, sectors and radios is also a consideration that carriers address in their network planning. Also considered is the impact of such additions on base station switching centers (BSCs), trunking (i.e., establishing queues to handle demand for voice and data channels), frequency management, and switching systems. However, because of the time and resources required in expanding existing systems, service providers must be careful to expand in accordance with growing needs. Expansion that occurs too soon often results in underutilization of equipment and capital resources required for the expansion. However, expansion that occurs too late often results in poor system performance and reliability, which often causes the loss of existing customers and possibly future customers.

Accordingly, system service providers need to be able to accurately and timely forecast existing wireless system demands and future wireless system growth. Conventional growth forecasting typically has been inadequate, with relatively simple linear models based on recorded traffic within the system often failing to accurately predict future system needs of existing wireless systems.

Thus, it would be desirable to have available a method, apparatus and system for forecasting growth within a wireless telecommunications system.

### SUMMARY OF THE INVENTION

The invention is embodied in a method, an apparatus, a computer readable medium and a system for forecasting growth within a wireless telecommunications system. The growth forecasting method includes determining current voice and data traffic for the wireless system, determining current minutes of use (MOU) for the current wireless system, estimating future MOU for the wireless system, and forecasting future traffic for the wireless system based on the system's current traffic, current MOU, and future estimated MOU. Also, the growth forecasting method includes allocating the forecasted future system traffic to the existing system in a suitable manner, e.g., according to the percentage contribution of each system sector to the existing system traffic. The growth forecasting method incorporates growth factors and buffer amounts as part of the system traffic forecasting. For example, the future MOU estimating step can incorporate MOU buffer and subscriber count buffer amounts. Also, the future MOU estimating step can incorporate growth factors, including an MOU growth factor and an individual sector busy hour (ISBH) growth factor, to reflect system growth rates during peak usage and non-peak usage. The apparatus includes at least one computer having instructions stored therein to cause the computer or computers to execute the forecasting method according to embodiments of the invention. The computer readable medium includes a set of computer instructions encoded thereon that are operative with one or more computers to cause the computer or computers to perform the forecasting method according to embodiments of the invention. The system includes one or more computers or other suitable devices that forecast growth of a wireless system according to embodiments of the invention. The growth forecasting method according to embodiments of the invention is suitable for forecasting traffic growth in wireless systems that use one or more different existing technologies, e.g., Global System for Mobile Communications (GSM), Advanced Mobile Phone Service (AMPS), Time Division Multiple Access (TDMA), and Code Division Multiple Access (CDMA). Also, the growth forecasting method is compatible with existing system traffic offload algorithms.

### BRIEF DESCRIPTION OF THE DRAWINGS

FIG. 1 is a simplified schematic diagram of a conventional wireless telecommunications system;

FIG. 2 is a simplified block diagram of a method for forecasting growth in a wireless telecommunications system according to embodiments of the invention;

FIG. 3 is a simplified schematic diagram of a wireless telecommunications system showing traffic offloading from existing sectors to a new sector according to embodiments of the invention; and

FIG. 4 is a simplified schematic diagram of a system for forecasting growth in a wireless telecommunications system according to embodiments of the invention, including an apparatus for forecasting growth in a wireless telecommunications system according to embodiments of the invention.

### DETAILED DESCRIPTION OF EXEMPLARY EMBODIMENTS

In the following description like reference numerals indicate like components to enhance the understanding of the invention through the description of the drawings. Also, although specific features, configurations and arrangements are discussed herein below, it should be understood that such is done for illustrative purposes only. A person skilled in the relevant art will recognize that other steps, configurations and arrangements are useful without departing from the spirit and scope of the invention.

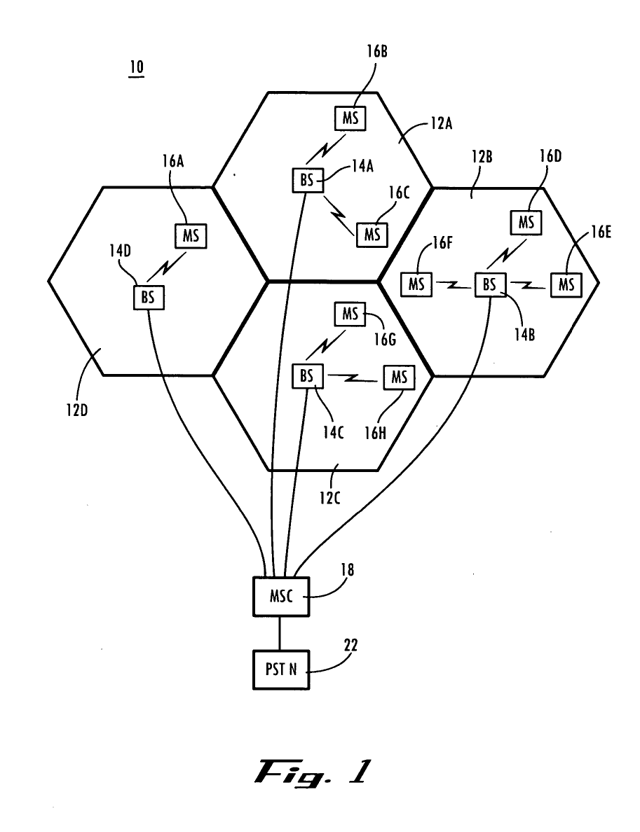

Referring now to FIG. 1, shown is a simplified, schematic diagram of a conventional wireless telecommunications system 10. The wireless system 10 provides wireless telecommunications services to a particular geographic area, which typically is divided into a plurality of contiguous radio coverage areas known as sectors or cells 12, e.g., sectors 12_{A}-12_{D}. Each sector 12 typically includes at least one central radio transmitter/receiver base station (BS) 14, e.g., BS_{A}-BS_{D}, for communicating with one or more mobile stations (MS) 16, e.g., MS_{A}-MS_{H}, that are located within the sector coverage area of a base station. As discussed hereinabove, mobile stations 16 include handheld personal units such as cellular telephones and other mobile communications devices that are used typically by system customers while traveling within or through a particular sector coverage area.

The wireless system 10 also includes a mobile services switching center (MSC) 18, which coordinates the routing of communications within the various sector coverage areas. For example, the MSC 18 coordinates and controls voice and data traffic the between the mobile stations 16 and the base stations 14, and between the base stations 14 and a fixed telecommunications network such as a fixed Public Switched Telephone Network (PSTN) 22.

In operation, a mobile station (MS) user places a cellular telephone call or otherwise transmits information from their mobile communications device by establishing a wireless connection, via a traffic channel (TCH), with one of the base stations in the sector area within which the mobile station user initiated the transmission. The voice and/or data traffic communicated by the mobile station 16 to the base station 14 is routed to an existing wireline network via the MSC 18 and the PSTN 22.

Each sector has a traffic capacity based on the number of base stations in the sector and the collective traffic capacity of the base stations in that sector. The traffic capacity of a given base station depends on the number of traffic channels (TCHs) the base station has been allocated. Typically, each base station has one or more control channels (CCH) and a plurality of traffic channels for voice or data transmission. The number of traffic channels allocated to a given base station depends on the number of transceiving units (TRXs) installed in that base station and functional allocation. Typically, a TRX is required for one or more simultaneously active traffic channel communication paths between that base station and a mobile station. Voice or data traffic capacity typically is measured in erlangs, which is defined as the amount of voice or data traffic (e.g., wireless voice or data traffic) in cumulative hours (i.e., aggregating all calls as if back-to-back) per hour of time.

As voice and data traffic within the wireless system 10 increases, the manner in which the wireless system 10 expands is of extreme importance to the system service provider. For example, the service provider to the wireless system 10 must decide whether to increase (or decrease) the number of sectors 12, whether to increase or decrease the number of base stations 14 in the existing sectors 12, whether to carve existing spectrum, whether to buy additional traffic capacity from another service provider and/or whether to increase (or decrease) the data transmission capacity of existing base stations 14 via the installation of additional TRX banks. Also, the system service provider must decide the most efficient manner in which to allocate additional TRXs into existing TRX banks within the existing base stations 14 throughout the wireless system 10.

Moreover, controlled expansion of the wireless system 10 is important because of the need to efficiently allocate expansion resources across the wireless system 10. That is, growth of the wireless system 10 should occur only when and where needed. If the traffic capacity of the wireless system 10 is expanded too slowly or in the wrong areas, the frequency with which mobile station end-users (e.g., customers) sometimes fail to access or maintain themselves on the wireless network will increase, possibly causing the loss of existing and future customers because of dissatisfaction with the system service. If the traffic capacity of the system is expanded too quickly or in the wrong areas, the resulting underutilization of resources used for expansion will reduce the service provider's return on investment. Thus, it is important to accurately predict growth within the wireless system 10.

To that end, embodiments of the invention include a method, an apparatus, a computer readable medium and a system for forecasting growth within a wireless telecommunications system. In general, the forecasting method uses current system traffic, current system minutes of use (MOU), and future system MOU to forecast growth for the wireless telecommunications system. The forecasted growth applies to future hardware and software requirements for the system's future radio, sector site, base station switching center (BSC) and mobile switching center (MSC) growth. The forecasted growth is useful to the system service provider for many planning tasks, including channel growth planning, capacity sector planning and spectrum management.

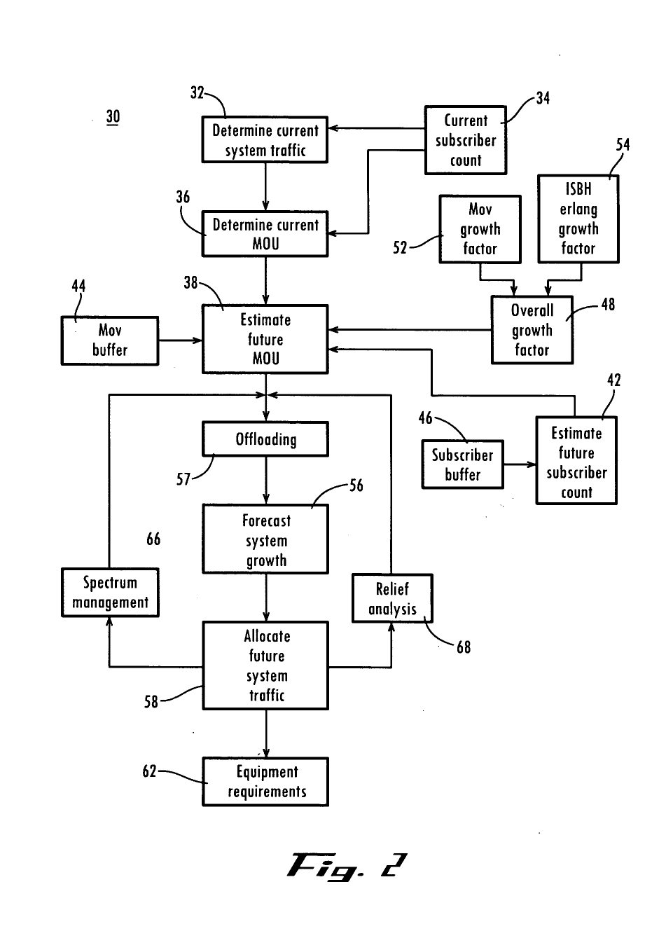

Referring now to FIG. 2, shown is a simplified block diagram of a method 30 for forecasting growth in the wireless telecommunications system 10 according to embodiments of the invention. One step 32 of the method 30 is to determine the current voice and data traffic for the wireless system 10. To determine the current voice and data traffic for the wireless system 10, the average hourly traffic of a given period, e.g., 15 daily busy hours, per sector (in erlangs) is collected from each sector of the system 10. The sum of the collected average traffic for all system sectors represents the total current traffic for the system 10. Along with determining the current system traffic, the current system determining step 32 also may obtain the current system subscriber count (shown as a step 34). The current system subscriber count typically is available from an appropriate source within the service provider's organization, e.g., the service provider's system accounting department or marketing department. Thus, according to embodiments of the invention, the current voice and data traffic for the system 10 is expressed in erlangs or erlangs per subscriber.

The next step 36 of the method 30 is to determine the current minutes of use (MOU) for the wireless system 10. For the service provider, the current MOU for the system 10 typically is available from a suitable source of the service provider, e.g., from the system accounting department or marketing department of the service provider. As part of the current MOU determining step 36, the current system subscriber count also may be obtained (i.e., the step 34). Thus, according to embodiments of the invention, the current system MOU is expressed in MOU or MOU per subscriber.

The next step 38 of the method 30 is to estimate the future MOU for the wireless system 10 for a given forecast period. In general, the estimating step 38 estimates the future system MOU based on the current system data traffic (i.e., the result of the determining step 32) and the current system MOU (i.e., the result of the determining step 34). The given forecast period is any suitable time period, e.g., a month or a trimester. The future system MOU estimating step 38 uses any suitable MOU and subscriber count estimating or forecasting technique employed by the system service provider. Thus, the future system MOU estimating step 38 obtains the future MOU and future subscriber count from the appropriate source within the service provider's organization, e.g., the system accounting department or the marketing department of the service provider.

The future system MOU estimating step 38 also can incorporate a step 42 of estimating the future subscriber count for the system 10 for the given forecast period. Thus, the future system MOU is expressed as total MOU for the system 10 or MOU per subscriber.

According to embodiments of the invention, the future system MOU estimating step 38 may incorporate an MOU buffer or MOU buffer amount into the MOU estimation (shown as 44). The MOU buffer typically is built into or is part of the estimating or forecasting technique employed by the service provider in estimating the future system MOU for the given forecast period. The MOU buffer component of the MOU estimation allows for some margin of error in estimating future MOU without disrupting the overall growth forecasting method 30.

Similarly, the future system MOU estimating step 38 may incorporate a subscriber count buffer or buffer amount into the MOU estimation (shown as 46). The subscriber count buffer typically is an available component of the estimating or forecasting technique employed by the service provider in estimating the future system subscriber count, i.e., the step 42. The subscriber count buffer component allows for some margin of error in estimating or otherwise determining the future subscriber count for the given forecast period.

According to embodiments of the invention, the future system MOU estimating step 38 typically incorporates one or more growth factors, e.g., growth factors that allow for peak hour usage and patterns of seasonal variation over time within the wireless system 10. An overall growth factor (shown as 48) includes any suitable number of growth factor components, e.g., an MOU growth factor (shown as 52) and an individual sector busy hour (ISBH) growth factor (shown as 54). The inclusion of one or more growth factors as part of the future system MOU estimating step 38 allows the overall forecasting method 30 to take into account and, to a certain extent, isolate system-specific variable factors such as system growth during peak hours of usage and system growth during non-peak hours of usage. In this manner, the overall forecasting method 30 produces a more accurate representation of actual system behavior and thus becomes more a more useful and accurate forecasting tool.

According to embodiments of the invention, the MOU growth factor 52, which typically is expressed as a ratio, provides some measure of the amount of MOU growth within the wireless system 10 for a given period of time. For example, according to an embodiment of the invention, the MOU growth factor is determined using a linear regression technique that uses actual MOU data from previous time periods, e.g., actual monthly MOUs. However, according to embodiments of the invention, other analysis techniques are suitable for use in determining the MOU growth factor 52.

According to embodiments of the invention, the individual sector busy hour (ISBH) growth factor 54, which typically is expressed in erlangs, incorporates the amount of system aggregate voice and data traffic during each individual sector's peak traffic usage hour or hours. As is typical within a wireless system, not only is voice and data traffic not constant from day to day, but voice and data traffic varies for given time intervals within the day. Thus, service providers often identify peak usage hour(s) or other time interval(s) for a given period of time (typically a 24-hour time period) for the overall system and for various network elements. In this manner, the system peak usage and individual sector busy hours data sometimes provides an estimation of the approximate maximum voice and data traffic experienced by the system. Also, identification of system peak usage and individual sector busy hours data allows a service provider to treat the peak usage hours differently than the non-peak usage hours in determining system usage. In many cases, the growth rate of a system's peak hour traffic differs greatly from the total growth rate of the system, i.e., the growth rate of the system traffic during the non-peak hours. Thus, by incorporating the ISBH growth factor 54 into the forecasting method 30, embodiments of the invention prevent the system peak usage and individual sector busy hours data from skewing otherwise relatively stable system usage and capacity measurements for the given time period.

According to an embodiment of the invention, the ISBH growth factor 54 is determined using a linear regression technique, which uses actual ISBH erlangs from previous time periods, e.g., daily ISBH erlang amounts from previous months. However, according to other embodiments of the invention, other analysis techniques are suitable for use in determining the ISBH growth factor 54.

The overall growth factor 48 typically is the ratio of the ISBH growth factor 54 to the MOU growth factor 52. The overall growth factor 48 reflects the differential rate of growth pattern on individual sectors for a given period of time relative to the overall MOU growth rate of the system. The overall growth factor 48, once determined, is applied to the future system MOU estimating step 38. In general, the overall growth factor 48 reflects the need for additional growth in system areas that experience variation in peak hour growth. Thus, such need is taken into account when estimating the future system MOU. Also, using the overall growth factor 48 as a component in the future system MOU estimating step 38 will limit the overestimation or underestimation of market growth that may have been skewed by measured peak usage hour voice and data traffic amounts.

According to embodiments of the invention, the future system MOU estimating step 38 estimates the voice and data traffic load on each sector for future points in time. The total of every sector's busy hour traffic load is referred to the system traffic pie, which typically is measured in erlangs. The system traffic pie serves as the system's total traffic budget from which erlangs are spread to the sectors according to embodiments of the invention.

The next step 56 of the method 30 is to forecast the future system traffic for the wireless system 10. According to embodiments of the invention, the future system traffic forecasting step 56 calculates the ratio of the current system traffic to the current system MOU and multiplies that ratio by the estimated future MOU for the first time period. The forecasted system traffic is expressed in erlangs. As discussed hereinabove, the current system traffic (expressed in erlangs) is determined by the current system traffic determining step 32, the current system MOU is determined by the current MOU determining step 36, and the future system MOU is the result of the future MOU estimating step 38.

According to embodiments of the invention, the method 30 also includes offloading algorithms that predict traffic for system sectors that offload traffic to and from other system sectors. Thus, the method 30 determines new system sector requirements and determines offload capabilities for various sectors in the system, shown as a step 57. For example, the offloading step 57 predicts future traffic to be carried by a newly added system sector that has traffic offloaded from one or more existing system sectors. Also, according to embodiments of the invention, the method 30 is compatible with and supports systems that use any one or more of different existing technologies, including, e.g., Global System for Mobile Communications (GSM), Advanced Mobile Phone Service (AMPS), Interim Standard 136 (IS-136), Time Division Multiple Access (TDMA), and Code Division Multiple Access (CDMA).

With respect to traffic offloading, the method 30 uses objective service levels as inputs and estimates the resources needed to support such levels consistent with the growth predictions of the overall traffic pie. The individual sectors that cannot support the objective service levels are identified as needing relief. Candidate sectors for these and other needs of the system service provider are identified in a cell site build plan. For each new cell on the build plan, a variable service date and traffic offload percentages are identified. The offload percentages are specific to the build plan being considered. A given amount of traffic is identified as offloadable from one or more other sectors that precede it in time in the build plan.

For example, referring now to FIG. 3, shown is the estimated coverage area of a new sector 64 to be placed in the system 10 based on factors such as strongest server signal tests and other suitable predictive methods. A region 65 of the new sector 64 that overlaps the existing sector 12_{C} represents the service area that is transferred to the new sector 64 from the existing sector 12_{C}, upon the integration of the new sector 64 into the system 10. The method 30 incorporates estimates of the traffic to be offloaded from the existing sector 12_{C} to the region 65 of the new sector 64. As the method 30 progressively projects traffic for various points on a future timeline, the method 30 identifies a point on the timeline where the services of the new sector 64 will be needed. At this future point in time, the method 30 determines the shift of traffic that is expected to occur and deducts the expected amount from the allocation of the existing sector 12_{C} and locks in this shifted traffic amount to the new sector 64 to establish a basis for the initial traffic load of the new sector 64. Similar determinations can be made for other regions in the new sector that overlap other existing sectors (e.g., sectors 12_{A}, 12_{B} and 12_{D}).

The method 30 then evaluates similar future points in time beyond this future transference, taking into account the impact to future growth to both donor and receiving sectors. For example, according to embodiments of the invention, the method 30 considers many future possible offload combinations of new and existing sectors, including the impact of new sectors that may get offloaded traffic and, in turn, are treated as existing sectors at some future time period thereafter. In this manner, determining future sector offloading and traffic shifting and projecting the resulting effect to the service provider's system enables an accurate prediction of traffic levels and hence voice and data channel requirements and network alternatives.

The next step 58 of the method 30 is to allocate the forecasted future system traffic throughout the existing system. According to an embodiment of the invention, the forecasted future system traffic is allocated among the existing system sectors based on the current percentage contribution of traffic to the overall current system traffic from each of the sectors 12 in the wireless system 10. Thus, for a sector whose current traffic represents 2.0% of the overall current system traffic, the allocation step 58 allocates 2.0% of the forecasted future system traffic to that sector. According to other embodiments of the invention, other suitable allocation techniques are used to allocate the forecasted future system traffic among the sectors of the current system.

Part of the allocation step 58 includes determining future requirements for the sectors based on the allocated growth of that sector resulting from the allocation step 58. Determining the requirements for the system sectors, which is shown as a step 62, includes determining the future equipment needs for the sectors, e.g., the number of base stations and base station TRX cabinets, based on the future forecasted traffic for that sector. Also, the allocation step 58 assists in determining the number of sectors that need to be added to (or removed from) the existing system.

Another step 66 of the method 30 is to evaluate the system sector capacities relative to the available RF spectrum, shown as Spectrum Management. A wireless service provider may have several coexisting wireless technologies serving the market. According to embodiments of the invention, the service provider evaluates different points of spectrum partitioning. The evaluation step 66 generates a Spectrum Management report that presents, e.g., in tabular form, spectrum carve point alternatives over the period of time being forecasted. The wireless service provider is able to choose the spectrum carve migration path over time that accommodates the level of traffic at objective levels of service while reducing the number of situations where network growth requires large amounts of capital.

Another step 68 of the method 30 includes a Relief Analysis Feature, which allows the system service provider to evaluate the impact of each new individual relief cell on the network. The relief analysis step 68 is useful in assessing the impact of certain strategies employing specific combinations of sectors placed into the system either simultaneously or in a given sequence. Furthermore, the relief analysis step 68 calculates the optimum timing of relief needs based on the scenario being considered and affords the service provider or other user a prioritization of the relative importance of each relief sector in the system.

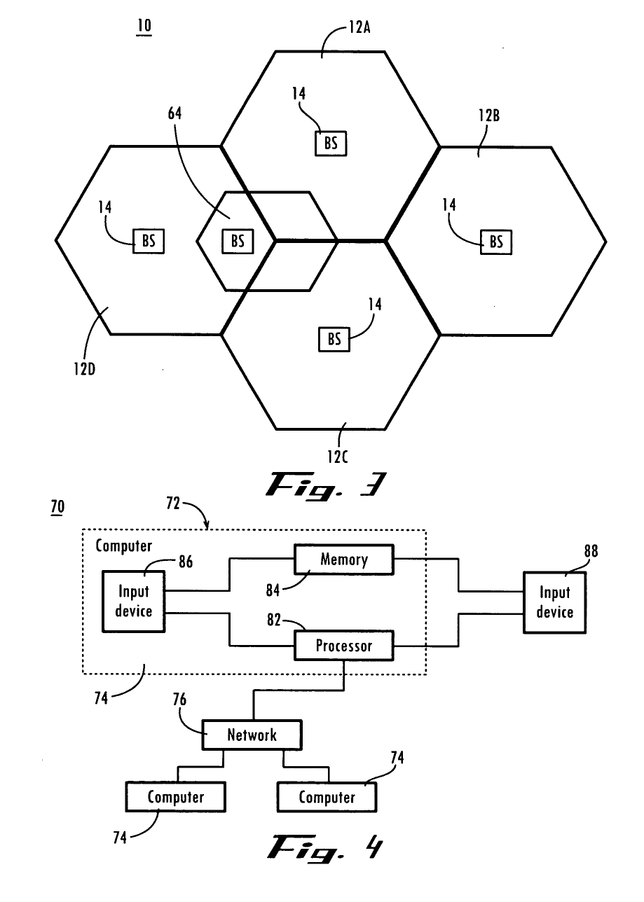

Referring now to FIG. 4, shown is a system 70 for forecasting growth and future traffic in the wireless telecommunications system 10 according to embodiments of the invention. The forecasting system 70 includes an apparatus 72 such as a computer for forecasting growth and future traffic in a wireless telecommunications system according to embodiments of the invention. The forecasting system 70 includes one or more computers 74 existing in a suitable arrangement, e.g., interconnected in a network via a network routing connector device 76 or other suitable networking device. One or more of the computers 74 has a processor 82, a memory device 84 in communication with the processor 82, and one or more input devices, e.g., a first input device 86 that is part of the computer 74 and/or a second input device 88 that is external to the computer 74 but operably connected to the computer 74.

One or more of the input devices 86, 88 receive input data such as current system traffic and current MOU for the wireless system 10, e.g., as discussed hereinabove in connection with the current system data traffic determining step 32 and the current MOU determining step 36, respectively. The memory device 84 stores, in the form of software or other suitable computer readable media, one or more sets of instructions encoded thereon to be executed by the processor 82. According to embodiments of the invention, the set of instructions include the future system MOU estimating step 38, the future system traffic forecasting step 56, the forecasted future system traffic allocation step 58, and other associated steps discussed hereinabove in connection with the method 30.

According to embodiments of the invention, the computer 74 executes the set of instructions stored in the memory device 84, causing the processor 82 to perform one or more of the steps stored in the memory device 84. That is, in general, the processor 82 determines the current system traffic based on information input into the computer 74, and determines the current system MOU based on information input into the computer 74. Also, the processor 82 estimates the future system MOU based on the current system traffic and the current system MOU, forecasts the future system traffic based on the current system traffic, the current system MOU and the estimated future system MOU, and allocates the forecasted future system traffic throughout the existing sectors 12 of the wireless system 10.

According to embodiments of the invention, the one or more computers 74 reside at any one or more of a number of suitable locations within the wireless system 10. Thus, the execution of the growth forecasting method 30 occurs at any one or more of a number of suitable locations within the wireless telecommunications system 10. For example, according to embodiments of the invention, the growth forecasting method 30 occurs in any one or more base stations, in the mobile switching center, in a global mobile switching center, in one or more on-site or in-the-network computers, in one or more off-site or out-of-the-network computers, or is distributed across several locations or devices including those just listed.

It will be apparent to those skilled in the art that many changes and substitutions can be made to the embodiments of the invention herein described without departing from the spirit and scope of the invention as defined by the appended claims and their full scope of equivalents.

1. A method for forecasting growth in a wireless telecommunications system, wherein the wireless telecommunications system includes a plurality of system sectors, the method comprising the steps of:
determining the current system traffic for the wireless telecommunications system;
determining the current minutes of use (MOU) for the wireless telecommunications system;
estimating the future minutes of use (MOU) for a first period of time for the wireless telecommunications system; and
forecasting the future system traffic for the wireless telecommunications system based on the current system traffic, the current system MOU and the future MOU.

2. The method as recited in claim 1, further comprising the step of allocating the future system traffic to the plurality of system sectors.

3. The method as recited in claim 2, wherein the allocating step allocates the future system traffic based on the percentage contribution of current system traffic of the plurality of sectors to the total of the current system traffic for the wireless telecommunications system.

4. The method as recited in claim 2, wherein the allocating step further comprises determining future equipment requirements for at least one of the plurality of system sectors.

5. The method as recited in claim 1, further comprising the step of determining the impact of proposed relief sectors for the system.

6. The method as recited in claim 1, further comprising the step of evaluating sector capacities relative to the available spectrum and the balance between coexisting technologies.

7. The method as recited in claim 1, wherein the current system traffic determining step includes determining the average traffic per sector per time period for at least one of the plurality of system sectors.

8. The method as recited in claim 1, wherein the MOU in the wireless telecommunications system includes MOU during peak time periods and MOU during non-peak time periods, and wherein the basis for determining future MOU in the future MOU estimating step includes a growth factor for MOU during peak time periods.

9. The method as recited in claim 8, wherein the growth factor includes a ratio of an individual sector busy hour (ISBH) erlang growth factor to an MOU growth factor.

10. The method as recited in claim 1, wherein the future MOU estimating step further comprises estimating the future MOU in such a way that the resulting MOU estimation includes an MOU buffer amount.

11. The method as recited in claim 1, wherein at least one of the current system traffic determining step and the current MOU determining step includes determining the number of current subscribers for the wireless telecommunications system.

12. The method as recited in claim 1, wherein the future MOU estimating step includes estimating the number of future subscribers for the wireless telecommunications system.

13. The method as recited in claim 12, wherein estimating the number of future subscribers for the wireless telecommunications system includes estimating the number of future subscribers in such a way that the resulting number of future subscribers includes a subscriber buffer amount.

14. The method as recited in claim 1, wherein the method further comprises forecasting growth in a wireless telecommunications system that uses a plurality of wireless transmission technologies, wherein the current system traffic determining step, the current MOU determining step, the future MOU estimating step and the forecasting step all are performed for at least one of the plurality of wireless transmission technologies.

15. The method as recited in claim 14, wherein the plurality of wireless transmission technologies includes Advanced Mobile Phone Service (AMPS), Interim Standard 136 (IS-136), Time Division Multiple Access (TDMA), Global System for Mobile Communications (GSM), Code Division Multiple Access (CDMA).

16. The method as recited in claim 1, wherein the method further comprises forecasting growth in the wireless telecommunications system for a first time period, wherein the future MOU estimating step further comprises determining future MOU for the first time period, and wherein the future data traffic forecasting step further comprises forecasting future system traffic based on the future MOU for the first time period, the current data traffic, and the current MOU.

17. An apparatus for forecasting growth in a wireless telecommunications system, wherein the wireless telecommunications system includes a plurality of system sectors, the apparatus comprising:
a computer for use in forecasting growth in a wireless telecommunications system, wherein the computer has at least one processor that executes at least one set of instructions, a memory device coupled to the at least one processor for storing the at least one set of instructions to be executed, and an input device coupled to the at least one processor and the memory device for receiving input data including current traffic data and current MOU data,
wherein the instructions stored in the memory device in the computer cause the at least one processor to
determine the current system traffic for the wireless telecommunications system based on the current traffic data,
determine the current minutes of use (MOU) for the wireless telecommunications system based on the current MOU data,
estimate future MOU for the wireless telecommunications system based on the current traffic data and the current MOU data, and
forecast future system traffic for the wireless telecommunications system based on the current system traffic, the current system MOU and the future MOU.

18. The apparatus as recited in claim 17, wherein the instructions stored in the memory device in the computer further cause the at least one processor to allocate the future system traffic to the plurality of system sectors.

19. The apparatus as recited in claim 18, wherein the instructions stored in the memory device in the computer further cause the at least one processor to allocate the future system traffic to the plurality of system sectors, and wherein the allocation includes determining future equipment requirements for at least one of the plurality of system sectors.

20. The apparatus as recited in claim 17, wherein the instructions stored in the memory device in the computer further cause the at least one processor to determine the impact of proposed relief sectors for the system.

21. The apparatus as recited in claim 17, wherein the instructions stored in the memory device in the computer further cause the at least one processor to evaluate sector capacities relative to the available spectrum and the balance between coexisting technologies.

22. A computer program for forecasting growth in a wireless telecommunications system, the computer program being embodied on a computer readable medium, the program comprising:
code for determining the current system traffic for a wireless telecommunications system based on current traffic data received by the computer,
code for determining the current minutes of use (MOU) for the wireless telecommunications system based on current MOU data received by the computer,
code for estimating the future MOU for the wireless telecommunications system based on the current traffic data and the current MOU data, and
code for forecasting the future system traffic for the wireless telecommunications system based on the current system traffic, the current system MOU and the future MOU.

23. The computer program as recited in claim 22, further comprising code for allocating the future system traffic to the plurality of system sectors.

24. The computer program as recited in claim 22, further comprising code for determining the impact of proposed relief sectors for the system.

25. The computer program as recited in claim 22, further comprising code for evaluating sector capacities relative to the available spectrum and the balance between coexisting technologies.

26. A system for forecasting growth in a wireless telecommunications system, wherein the wireless telecommunications system includes a plurality of system sectors, the system comprising:
at least one computer interconnected in a network for use in forecasting growth in the wireless telecommunications system, the plurality of computers having
at least one processor,
a memory device coupled to the at least one processor for storing at least one set of instructions to be executed, and
an input device coupled to the at least one processor and the memory device for receiving input data including current traffic data and current MOU data,
wherein at least one computer is operative to execute the at least one set of instructions, and the at least one set of instructions stored in the memory device in the at least one computer causing the at least one processor associated therewith to:
determine the current system traffic for the wireless telecommunications system,
determine the current minutes of use (MOU) for the wireless telecommunications system,
estimate the future MOU for the wireless telecommunications system, and
forecast the future system traffic for the wireless telecommunications system based on the current system traffic, the current system MOU and the future MOU.

27. The system as recited in claim 26, wherein the instructions stored in the memory device in the computer further cause the at least one processor to allocate the future system traffic to the plurality of system sectors.

28. The system as recited in claim 26, wherein the instructions stored in the memory device in the computer further cause the at least one processor to allocate the future system traffic to the plurality of system sectors, and wherein the allocation includes determining future equipment requirements for at least one of the plurality of system sectors.

29. The system as recited in claim 26, wherein the instructions stored in the memory device in the computer further cause the at least one processor to determine the impact of proposed relief sectors for the system.

30. The system as recited in claim 26, wherein the instructions stored in the memory device in the computer further cause the at least one processor to evaluate sector capacities relative to the available spectrum and the balance between coexisting technologies.
